(19) United States
(12) Patent Application Publication
(10) Pub. No.: US 2009/0071889 A1
(43) Pub. Date: Mar. 19, 2009

(54) Magnetic field generating device for polarizing fluids and distribution components using the same

(76) Inventors: Juan Manuel Corpa Arenas, Valencia (ES); Javier Romero Gomez, Rocafort (ES); Juan Jose Mollar Capdevila, Villareal (ES); Vicente Rogla Benedito, Valencia (ES); Jose Ventura Remolar, Bechi (Castellon) (ES); Jose Manuel Fortuno Ferriols, Villareal (Castellon) (ES)

Correspondence Address: THOMPSON & KNIGHT, L.L.P.;PATENT PROPERTY DEPARTMENT, 1722 ROUTH STREET, SUITE 1500, DALLAS, TX, 75201-2533, US

(21) Appl. No.: 12/231,833

(22) Filed: Sep. 5, 2008

Related U.S. Application Data
(60) Provisional application No. 60/993,182, filed on Sep. 10, 2007.

(51) Int. Cl. C02F 1/48

(52) U.S. Cl. 210/222

(57) ABSTRACT

The invention describes a device that can generate a magnetic field, such as a solenoid or magnet, with a shape and insulation allowing it to be crossed by a liquid which will be polarized. The magnetic field generated is regular so that its effect on the liquid passing through the device will be uniform. Due to its preferably tubular shape, the device may be fitted in any liquid distribution system or it can even, due to its tubular shape, replace a segment of said circuits.

### CROSS REFERENCE TO RELATED APPLICATION

This application claims the benefit of U.S. Provisional Patent Application No. 60/993,182, filed Sep. 10, 2007.

### FIELD OF INVENTION

The invention relates to devices and methods for generating magnetic fields, and in particular to devices and methods for generating circular magnetic fields suitable for polarizing a liquid or fluid.

### BACKGROUND OF INVENTION

The use of magnets or solenoids to polarize water or other liquids or fluids is not new, and has been known since Ancient Greece, where polarized liquids were considered to be curative and healthy. The most common form of water polarization is found in connection with in containers such as bath tubs. For example, U.S. Pat. No. 5,758,369 refers to a container or bath tub in which the container itself has inlet orifices that polarize the water and outlet orifices that direct the water in a closed circuit. Additionally, Patent Application No. PCT/US97/20972 refers to a bath tub in which devices that can generate magnetic fields are disposed on both of the bath tub sides and out of contact with the water.

Disadvantageously, currently known systems for polarizing a liquid are complex, limited to fixed installations, or both, which makes them impractical, particularly when considering the space limitations in typical homes. Additionally, the aforementioned systems require that the user be immersed in water in order for the effects of the polarization to act on the user, which prevents their use in many applications, such showers.

In addition to the aforementioned solutions, polarizing devices are also known that consist of magnets inserted in the pipes carrying the fluids; however, this technique can only be used with magnets, not with solenoids, with the corresponding limitations, particularly regarding controlling the magnetic filed intensity.

### SUMMARY OF INVENTION

According to one embodiment of the principles of the present invention, disclosed is an improved magnetic field generating device of the type that a solenoid or a magnet to polarize a fluid or liquid, essentially characterized in that its shape and insulation conditions allow the liquid or fluid to pass through the magnetic field generating device so that the fluid or liquid is polarized.

Preferably, the magnetic field created by the device is circular, so that it has a very regular incidence on the fluid or liquid stream, favoring a uniform polarization of the liquid or fluid. Depending on the type of magnetic field desired, with fixed or variable intensity, continuous or alternating, either a magnet or a solenoid can be used. The use of solenoids is recommended in case in which it is desired to regulate the field intensity.

The applications of these devices are numerous, as they can be used in any type of installation in which it is advantageous to have an outlet of polarized liquid, mainly water. Examples include bath tubs, shower columns, and water massage columns, among others. Furthermore, these devices can be disposed in a common pipe, a water massage nozzle, a shower head or a point of a water distribution circuit.

### BRIEF DESCRIPTION OF DRAWINGS

FIG. 1 is a diagram of a fluid polarization system according to an exemplary embodiment of the present invention.

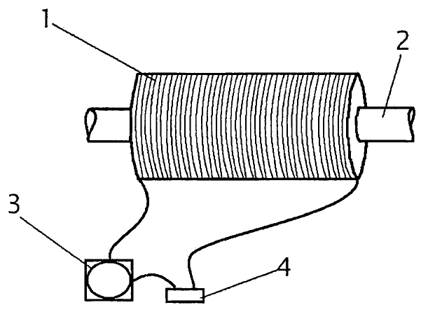

### DETAILED DESCRIPTION OF THE INVENTION

To solve the problems mentioned above, the invention herein described includes a magnetic field generating device 1, such as a magnet or a solenoid, surrounding a duct 2 inside which runs a liquid, preferably water, such that the liquid is polarized. Advantageously, magnetic field generating device 1 generates a circular magnetic field such that the liquid inside is evenly affected, which makes the polarization regular and controllable.

For a fixed intensity magnetic field, magnetic field generating device 1 preferably comprises a magnet. Alternatively, for a variable intensity magnetic field, magnetic field generating device 1 preferably comprises a solenoid or similar electromagnet. In this case, a potentiometer 3 and current source 4 allow for the generation of a magnetic field that can be either fixed or variable in intensity. The magnetic field created can be continuous, pulsating, or alternating according to the desired effect to be obtained by polarizing the liquid.

If magnetic field generating device 1 includes a solenoid that requires connection to an electrical power grid, magnetic field generating device 1 and/or duct 2 are provided with a sufficient insulator to prevent electricity from passing into the liquid stream. If a magnet is used, potentiometer 3, current source 4, and/or the associated insulation are not necessary.

Duct 2 can form a portion of a pipe or water outlet, fitted at a point along a pipe, form a water outlet itself, or form a part of a water distribution circuit. Hence, among other things, the benefits of the embodiments of the present invention can be realized simply by installing magnetic field generator 1 at a shower head or water massage column. Consequently, after the water is polarized, the beneficial effects of the polarized water can be enjoyed without the user having to be immersed in the water. When the device is fitted on the outlet point of the water, for example, is that the positive effects of the polarization will be transmitted to the user without the user having to be submerged in the liquid.

In sum, a preferred embodiment of the invention comprises tubular shaped device including a solenoid or magnet, such that a stream of liquid, preferably water, passes through a central gap of the solenoid or magnet such that it is subjected to the magnetic field generated by the solenoid or magnet and is thereby polarized. The final shape and size of the device will be determined by its intended function and the size of the solenoid calculated for the required uses.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. An improved magnetic field generating device of the type of those essentially using a solenoid or a magnet to polarize water, essentially characterized in that its shape and insulation conditions allow a liquid or fluid to pass through it so that it is polarized.

2. An improved magnetic field generating device according to claim 1, essentially characterized in that it generates a circular magnetic field that affects the liquid passing through it in a regular and uniform manner.

3. An improved magnetic field generating device according to claim 1, essentially characterized in that it is adapted to fit in a water outlet of a shower, bath or water massage system.

4. A water distribution system component of the type consisting of a tubular body one end of which is adapted to be connected to a water distribution system and the other being free, and adapted to eject water, essentially characterized in that said tubular body is constituted by a solenoid or a magnet.

5. A water distribution system component of the type with a preferably tubular shape used to join a pipe segment in a distribution circuit of water or another liquid, essentially characterized in that said preferably tubular element consists of a solenoid or a magnet.
